(19) United States
(12) Patent Application Publication
(10) Pub. No.: US 2014/0333555 A1
(43) Pub. Date: Nov. 13, 2014

(54) TOUCH SENSOR AND ELECTRONIC DEVICE HAVING THE SAME

(71) Applicant: SAMSUNG ELECTRO-MECHANICS CO., LTD., Suwon-Si (KR)

(72) Inventors: Sang Hwan Oh, Suwon-Si (KR); Sang lk Cho, Suwon-Si (KR); Woo Jin Lee, Suwon-Si (KR); Hyung Ho Kim, Suwon-Si (KR)

(73) Assignee: SAMSUNG ELECTRO-MECHANICS CO., LTD., Suwon-Si (KR)

(21) Appl. No.: 14/273,446

(22) Filed: May 8, 2014

(30) Foreign Application Priority Data
May 10, 2013 (KR) 10-2013-0053333
Feb. 14, 2014 (KR) 10-2014-0017421

(51) Int. Cl. G06F 3/041

(52) U.S. Cl. CPC G06F 3/041
USPC 345/173

(57) ABSTRACT

A touch sensor includes a transparent substrate, first electrode patterns formed on one surface of the transparent substrate, second electrode patterns formed to intersect with the first electrode patterns, the second electrode patterns spaced apart from the first electrode patterns, wiring parts formed on one end or both ends of the first electrode patterns and the second electrode patterns to electrically connect between the first electrode patterns and the second electrode patterns. The first and second electrode patterns comprise thin metallic wires conducting with the wiring parts. An area occupied by the thin metallic wire per unit area on the first electrode pattern may be different from an area occupied by the thin metallic wire per unit area on the second electrode pattern.

### CROSS REFERENCE TO RELATED APPLICATION

This application claims the benefit of Korean Patent Application No. 10-2014-0017421, filed on Feb. 4, 2014, entitled “Touch Sensor And Electronic Device Having The Same” which is hereby incorporated by reference in its entirety into this application.

### BACKGROUND

1. Technical Field

The present technology generally relates to a touch sensor and an electronic device having the same.

2. Description of the Related Art

With the development of computers using a digital technology, computer-aided devices have been developed, and personal computers, portable transmitters and other personal information processors execute processing of texts and graphics using a variety of input devices such as a keyboard and a mouse.

With the rapid advancement of an information-oriented society, the use of computers has gradually been expanded. However, it is difficult to efficiently operate products using only a keyboard and a mouse which currently serve as input devices. Therefore, the necessity for a device, which has a simple configuration and less malfunction and is configured for anyone to easily input information, has increased.

In addition, technologies for input devices have progressed toward techniques related to high reliability, durability, innovation, designing and processing, and the like, in addition to satisfying general functions. To this end, a touch sensor has been developed as input devices capable of inputting information such as texts and graphics.

This touch sensor is equipment which is mounted on a surface of a display such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the display.

A type of the touch sensor may be classified into a resistive type, a capacitive type, an electro-magnetic type, a surface acoustic wave (SAW) type, and an infrared type. These various types of touch sensors have been adapted for electronic products in consideration of a signal amplification problem, a resolution difference, a difficulty of designing and processing to technology, optical characteristics, electrical characteristics, mechanical characteristics, anti-environment characteristics, input characteristics, durability, and economic efficiency. Currently, the resistive type touch sensor and the capacitive type touch sensor have been used in a wide range of fields.

In the touch sensor like Japanese Patent Application Publication No. 2011-175967 Al, the electrode pattern made of metal has been used. As such, when the electrode pattern is made of metal, electric conductivity may be excellent and supply and demand may be smooth. However, the user may visualize electrode patterns made of metal. In particular, to prevent an electrical short between respective electrode patterns during a process of forming an electrode pattern, a short wire part is formed between the electrode patterns to insulate the electrode patterns and thus a shape of the short wire part is different from electrode patterns, such that the electrode patterns may be more recognized by the user.

### SUMMARY

Some embodiments of the present invention may facilitate control of mutual capacitance of electrode patterns configured of sensing electrodes and driving electrodes by forming first electrode patterns and second electrode patterns configuring the electrode patterns of a touch sensor in the same width and more increasing the size of a mesh pattern of any one of the electrode patterns.

Some embodiments of the present invention may reduce visibility of electrode patterns by forming dummy patterns inside mesh patterns forming the electrode patterns to resolve a visibility problem of the electrode patterns due to the relative increase in the size of the mesh pattern of any one of the electrode patterns.

According to a preferred embodiment of the present invention, a touch sensor may include a transparent substrate; one or more first electrode patterns formed on one surface of to the transparent substrate, one or more second electrode patterns formed to intersect with the first electrode patterns, the second electrode patterns spaced apart from the first electrode patterns, and wiring parts formed on one end or both ends of the first and second electrode patterns to electrically connect between the first electrode patterns and the second electrode patterns. The first and second electrode patterns may comprise thin metallic wires conducting with the wiring parts. An area occupied by the thin metallic wires per unit area on the first electrode pattern may be different from an area occupied by the thin metallic wires per unit area on the second electrode pattern.

The first electrode pattern may be a sensing electrode and the second electrode pattern may be a driving electrode.

Unidirectional widths of the first electrode patterns and the second electrode patterns may be formed to correspond to each other.

The second electrode patterns may be formed on the other surface of the transparent substrate.

The touch sensor may further comprise another transparent substrate. The second electrode pattern may be formed on another transparent substrate to be spaced apart from the first electrode patterns in a direction facing each other.

The touch sensor may further include an insulating resin formed on the transparent substrate and formed between the first electrode patterns and the second electrode patterns on one surface thereof.

The area occupied by the thin metallic wires on the first electrode pattern and the area occupied by the thin metallic wires on the second electrode pattern may be different from each other within an area corresponding to a region in a stacked direction of the first electrode pattern and the second electrode pattern.

The area occupied by the thin metallic wires per unit area on the first electrode pattern may be formed to be smaller than that occupied by the thin metallic wires per unit area on the second electrode pattern.

The area occupied per unit area of the thin metallic wire may be determined by any one of a line width, a pitch, and a pattern of the thin metallic wires or a combination thereof.

The touch sensor may further include one or more dummy electrodes formed inside the first electrode patterns and formed to be insulated from the first electrode patterns.

The dummy electrode may be formed inside the first electrode patterns so that a difference between an aperture ratio per unit area of the first electrode pattern and an aperture ratio per unit area of the second electrode pattern is set to be 1% or less.

The dummy electrode formed inside the first electrode patterns may be formed with a pattern corresponding to the second electrode pattern.

The touch sensor may further include at least one or more first unit pattern formed inside the first electrode patterns, and at least one or more second unit pattern formed inside the second electrode patterns.

The number of the first unit patterns formed per unit length in one direction in which the first electrode patterns and the second electrode patterns correspond to each other may be smaller than the number of the second unit patterns.

The number of the second unit patterns formed per unit length in one direction in which the first electrode patterns and the second electrode patterns correspond to each other may be formed to be an integer multiple of the number of the first unit patterns.

The number of the first unit patterns formed per unit length in the other direction intersecting with one direction in which the first electrode pattern and the second electrode pattern correspond to each other may be smaller than the number of the second unit patterns.

The number of the second unit patterns formed per unit length in the other direction intersecting with one direction in which the first electrode patterns and the second electrode patterns correspond to each other may be formed to be an integer multiple of the number of the first unit patterns.

The first unit patterns and the second unit patterns may be formed of the thin metallic wire having a closed loop structure.

At least one first unit pattern having a closed loop structure may be formed inside the first electrode patterns, and the dummy electrode may be formed inside the closed loop.

The touch sensor may further include at least one cutting part for controlling mutual capacitance formed inside the first electrode patterns.

The touch sensor may further include a window substrate formed at an outermost of the sensing electrode to which a touch of a user is input, and a display unit formed to be disposed at a lower portion of the driving electrode.

In some embodiments, a touch sensor may comprise a transparent substrate, first electrode patterns formed on one surface of the transparent substrate, and second electrode patterns disposed to be spaced apart from the first electrode patterns. A mesh density of the first electrode patterns may be different from a mesh density of the second electrode patterns.

The touch sensor may further comprise one or more dummy electrodes arranged inside one of the first electrode patterns and the second electrode patterns which has a lower mesh density than the other, or inside both of the first and second electrode patterns.

The dummy electrodes may be formed to be insulated from the first and/or second electrode patterns.

The touch sensor may further comprise a short wire part between the first electrode patterns and/or between the second electrode patterns.

### BRIEF DESCRIPTION OF THE DRAWINGS

Embodiments of the present invention will be more clearly understood from the following detailed description taken in conjunction with the accompanying drawings, in which:

FIG. 1 is a cross-sectional view of a touch sensor according to a preferred embodiment of the present invention;

FIG. 2 is a plan view of a first electrode pattern according to a preferred embodiment of the present invention;

FIG. 3 is a plan view of a second electrode pattern according to a preferred embodiment of the present invention;

FIG. 4 is a plan view of an electrode pattern including a dummy electrode according to a preferred embodiment of the present invention;

FIG. 5 is a plan view of a first electrode pattern including a first unit pattern according to a preferred embodiment of the present invention;

FIG. 6 is a plan view of a second electrode pattern including a second unit pattern according to a preferred embodiment of the present invention;

FIG. 7 is a plan view of a first electrode pattern and a second electrode pattern including dummy electrodes according to a preferred embodiment of the present invention;

FIG. 8 is a plan view illustrating a region in which the first electrode pattern and the second electrode pattern according to the preferred embodiment of the present invention face each other;

FIG. 9 is a cross-sectional view of a touch sensor according to another preferred embodiment of the present invention; and

FIGS. 10A and 10B are diagrams illustrating examples of a distribution form of a thin metallic wire according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the embodiments, when to it is determined that the detailed description of the related art would obscure the gist of the present invention, the description thereof will be omitted.

Hereinafter, a touch sensor according to preferred embodiments of the present invention will be described in detail with reference to the accompanying drawings.

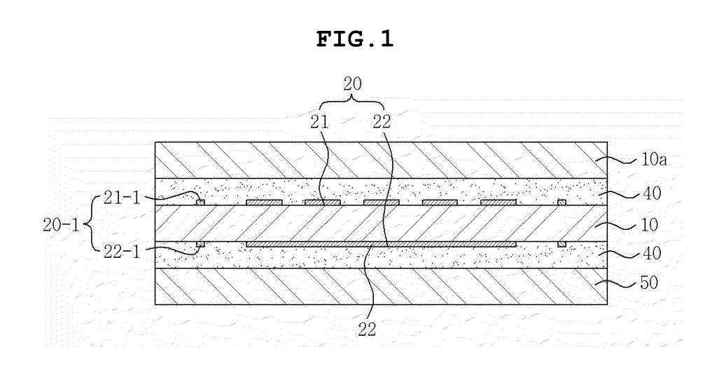

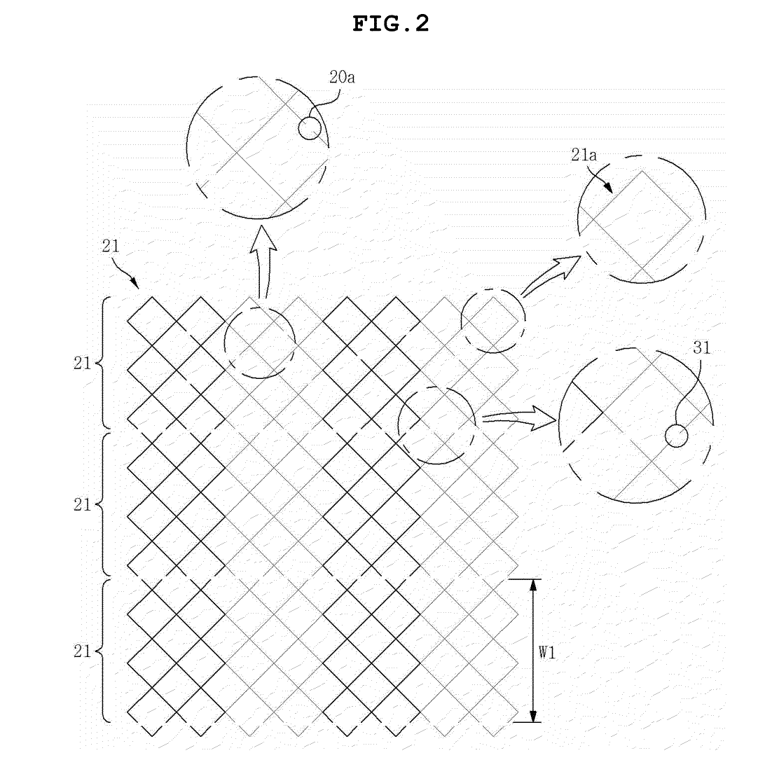

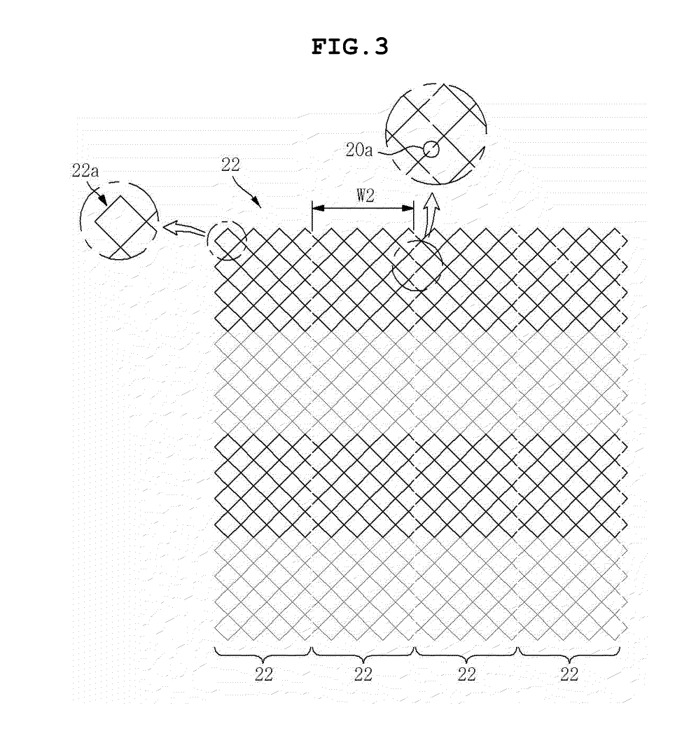

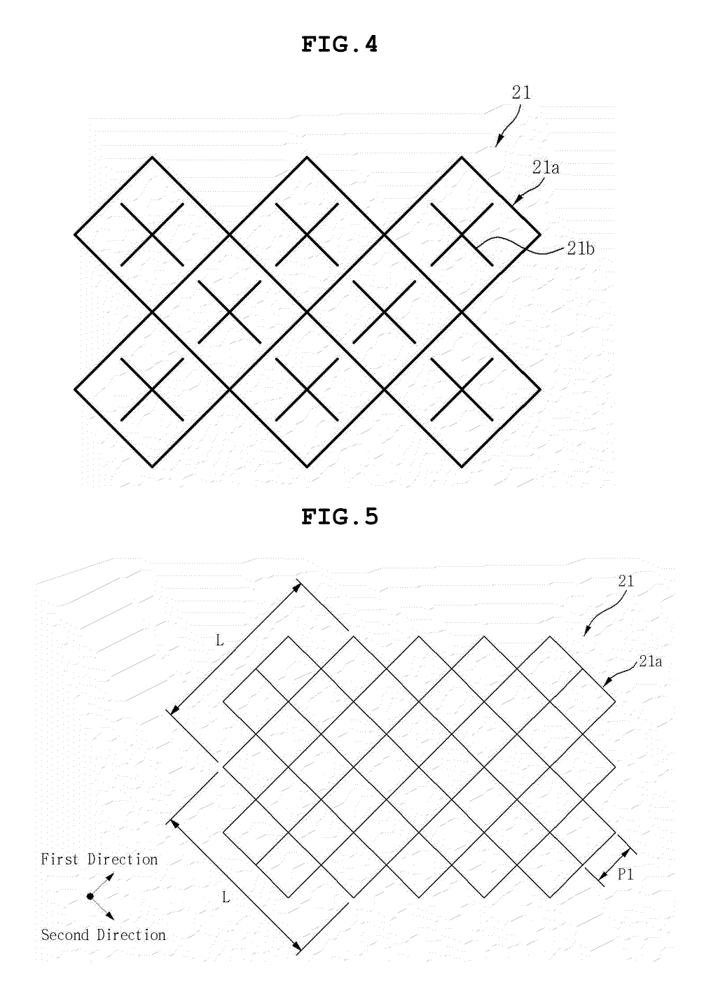

FIG. 1 is a cross-sectional view of a touch sensor according to a preferred embodiment of the present invention, FIG. 2 is a plan view of a first electrode pattern 21 according to a preferred embodiment of the present invention, and FIG. 3 is a plan view of a second electrode pattern 22 according to a preferred embodiment of the present invention.

The touch sensor according to the preferred embodiment of the present invention may include a transparent substrate 10, one or more first electrode patterns 21 which are formed on one surface of the transparent substrate 10, one or more second electrode patterns 22 which are formed to intersect with the first electrode patterns 21 and formed to be spaced apart from the first electrode patterns 21, wiring parts 20-1 which are formed on one end or both ends of the first electrode patterns 21 and the second electrode patterns 22 to electrically connect between the first electrode patterns 21 and the second electrode patterns 22. Thin metallic wires 20-2 may form the first electrode pattern 21 and the second electrode pattern 22 and conduct with the wiring part 20-1. An area occupied by the thin metallic wires 20-2 per unit area on the first electrode patterns may be different from an area occupied by the thin metallic wires 20-2 per unit area on the second electrode patterns.

The transparent substrate 10 of the touch sensor may be made of any material which may have transparency and output an image of a display unit 50 without being particularly limited to a material which has a predetermined strength. The transparent substrate 10 may be made of, for example, but not limited to, polyethylene terephthalate (PET), polycarbonate (PC), poly methyl methacrylate (PMMA), polyethylene naphthalate (PEN), polyethersulpon (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass. Further, one surface of the transparent substrate 10 may be formed with the electrode pattern 20 and therefore a surface treating layer may be formed by performing high frequency treatment, primer treatment, and the like on the one surface of the transparent substrate 10 so as to improve an adhesion between the transparent substrate 10 and the electrode pattern 20.

The first electrode patterns 21 may be formed on one surface of the transparent substrate 10 in one direction, and the second electrode pattern 22 is formed on the other surface of the transparent substrate 10 to correspond to the first electrode pattern 21. However, the second electrode pattern 22 may be formed in the direction vertical to the first electrode pattern 21. In this case, an intersecting angle is not particularly limited, and the intersecting angle at which the electrode patterns 20 in the two directions intersect each other to be able to calculate coordinates on a two-dimensional plane may be changed in a design.

The first electrode pattern 21 and the second electrode pattern 22 may each serve as a sensing electrode and a driving electrode. The example of the first electrode pattern 21 as the sensing electrode and the second electrode pattern 22 as the driving electrode will be described herein. However, the differentiation between the sensing electrode and the driving electrode depending on the functions of the first electrode pattern 21 and the second electrode pattern 22 is not limited thereto and a structure of each electrode pattern 20 is not limited by the above functions.

The touch sensor generally has a structure to supply a signal to the driving electrode and receive the signal through the sensing electrode. For example, when the touch sensor is touched by a finger, etc., the signal transferred to the sensing electrode is changed and the touch sensor senses the change in the signal to recognize whether the touch sensor is touched. The driving electrodes of the second electrode patterns 22 which are coupled on the display unit 50 may be formed in a bar type having a wide width so as to minimize a distance between the second electrode patterns 22, thereby shielding noises occurring from the display unit 50. As described below, an inactive region between the second electrode patterns 22 formed in parallel may be removed or reduced to shield the noises from the display unit 50 while improving signal transfer to the driving electrode. For convenience, the first electrode pattern 21 is described as the sensing electrode and the second electrode pattern 22 is described as the driving electrode. However, the first electrode pattern 21 and the second electrode pattern 22 may each serve as any one of the sensing electrode and the driving electrode.

The wiring parts 20-1 may each be provided with first electrode wirings 21-1 and second electrode wirings 22-1 to which electrical signals of the first electrode patterns 21 and the second electrode patterns 22 are transferred. The wiring parts 20-1 may be integrally formed with the first and second electrode patterns 21 and 22 to simplify the manufacturing process. The wiring parts 20-1 may be made of a material composed of silver (Ag) paste or organic silver having excellent electric conductivity but is not limited thereto. Further, the wiring parts 20-1 may be integrally formed to electrically connect one or both ends of the first electrode pattern 21 and the second electrode pattern 22. As illustrated in FIGS. 2 and 3, the first electrode pattern 21 and the second electrode pattern 22 may be formed of mesh patterns which are formed by continuously arranging at least one unit patterns 21a and 22a. The first electrode patterns 21 and the second electrode patterns 22 may have short wire parts 31. The short wire parts 31 may be disposed on boundary parts between the respective electrode patterns 20 so that each of the at least two electrode patterns may be disposed in parallel to be insulated from each other, thereby reducing the visibility and forming the insulating part. Further, the short wire parts 31 are disposed on the boundary parts to be different irregular linear types, thereby effectively reducing the visibility of the electrode pattern 20. A spaced distance between the short wire parts 31 may be formed to be 30 μm or less and the reliability of insulation between the electrode patterns 20 and the visibility of the electrode pattern 20 may be reduced by adjusting the distance between the short wire parts 31.

Herein, the unit patterns may have a closed loop structure to be mutually conducted on the electrode patterns 20 and may have various shapes such as a quadrangle, a diamond, a parallelogram, and the like. Further, when the electrode pattern 20 is formed in an irregular or random pattern, the unit patterns may be formed by combining various shapes having different forms with each other.

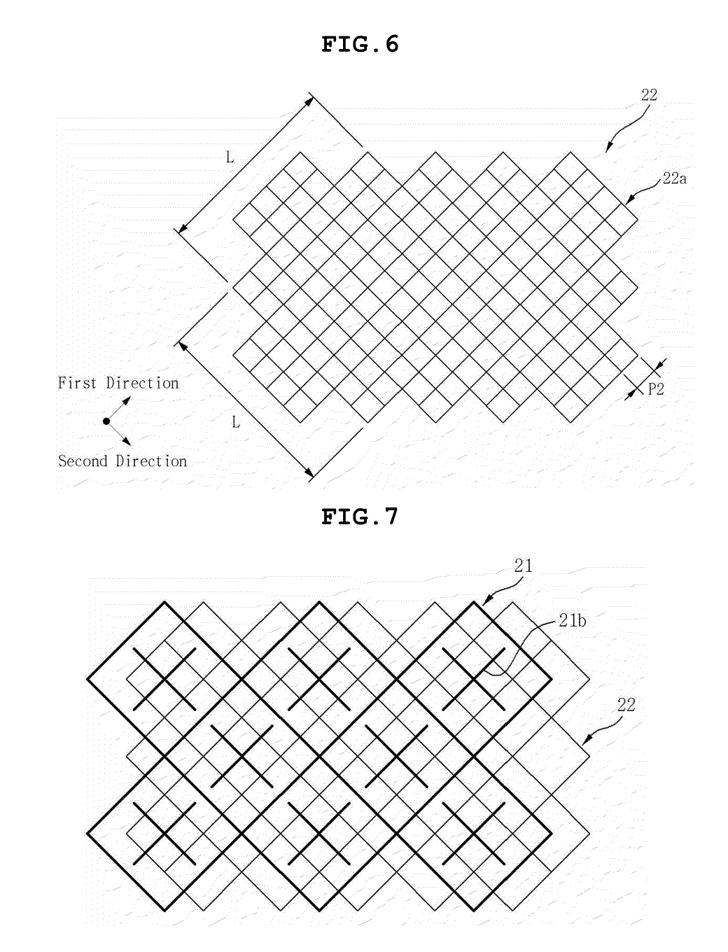

As illustrated in FIGS. 5 and 6, for describing the preferred embodiment of the present invention, a pitch between the first unit patterns 21a forming the first electrode patterns 21 is indicated by P1, and a pitch between the second unit patterns 22a forming the second electrode patterns 22 is indicated by P2. Further, the first electrode patterns 21 may be repeatedly arranged so that the plurality of same first unit patterns 21a are continuously coupled with each other, and the second electrode patterns 22 may also be repeatedly arranged so that the plurality of second unit patterns 22a are continuously coupled with each other.

To reduce the visibility of the thin metallic wires 20-2 in the opaque mesh patterns forming the electrode patterns 20 of the touch sensor, a width W1 of the first electrode pattern 21 may be formed to be same as a width W2 of the second electrode pattern 22. Here, when the first electrode pattern 21 is formed as the sensing electrode and the second electrode pattern 22 is formed as the driving electrode, to control a mutual capacitance between the first electrode pattern 21 and the second electrode pattern 22 in a proper range, the pitch P1 between the first unit patterns 21a of the first electrode pattern 21 is set to be an integer multiple as large as the pitch P2 between the second unit patterns 22a, such that the mutual capacitance between the first electrode pattern 21 and the second electrode pattern 22 may be controlled even though the electrode patterns 20 have the same width.

Further, cutting parts 20a may be formed inside the first electrode pattern 21 or the second electrode pattern 22 to be able to appropriately control the mutual capacitance even though the same pattern is formed. The cutting parts 20a may be formed at an interval of 30 μm or less within a range to reduce the visibility on the electrode patterns 20.

According to the preferred embodiment of the present invention, as illustrated in FIGS. 5 an 6, when viewed in the unit length L in a first direction or a second direction in each electrode pattern 20, the number of second unit patterns 22a may be formed to be smaller than the number of first unit patterns 21a, and the number of second unit patterns 22a may be formed at an integer multiple of the number of first unit patterns 21a. However, this is only one example and therefore even though the number of second unit patterns 22a is not necessarily formed at an integer multiple of the number of the first unit patterns 21a. The number of second unit patterns 22a may be formed to be larger than the number of first unit patterns 21a, and therefore the second unit patterns 22a may be variously combined with each other so that the areas occupied by the thin metallic wires 20-2 formed per unit area of the first electrode pattern 21 and an the second electrode pattern 22 are different from each other.

Therefore, the number and shapes of first unit patterns 21a and second unit patterns 22a included in the first electrode pattern 21 and the second electrode pattern 22 may be variously changed so that an area value occupied by the thin metallic line 20-2 per unit area on the first electrode pattern 21 and an area value occupied by the thin metallic wire 20-2 per unit area on the second electrode pattern 22 are formed to be different from each other. That is, the lengths in the width direction of the first electrode pattern 21 and the second electrode pattern 22 having density values (the density value is defined by the area value occupied by the thin metallic wire 20-2 per unit area on the electrode pattern) of different thin metallic wires 20-2 correspond to each other, thereby appropriately controlling the mutual capacitance and more effectively reducing the visibility of the mesh pattern forming the electrode pattern 20.

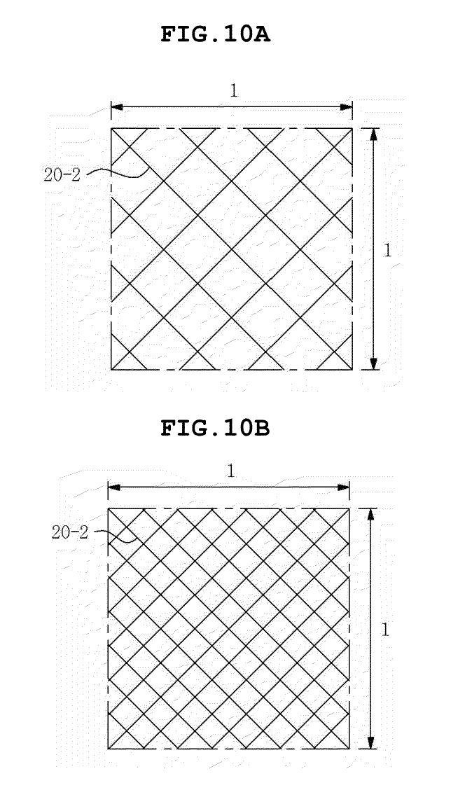

Although the preferred embodiment of the present invention illustrates and describes the electrode pattern 20 having the form in which the density value of the thin metallic wire 20-2 forming the first electrode pattern 21 is smaller than that of the thin metallic wire 20-2 forming the second electrode pattern 22 (see FIGS. 2 and 3), the to electrode pattern 20 may be formed to the contrary thereto or variously. For example, as illustrated in FIGS. 10A and 10B, the density value of the thin metallic wire 20-2 may be controlled based on more various methods by controlling the number and shapes of unit patterns of each electrode pattern and the pitches between the respective unit patterns or a line width between the thin metallic wires 20-2 so that the area value occupied by the thin metallic wire 20-2 per unit area illustrated in FIG. 10A is smaller than the area value occupied by the thin metallic wire 20-2 per unit area illustrated in FIG. 10B.

When a difference between an aperture ratio of the first electrode pattern 21 and the second electrode pattern 22 depending on the density values of the thin metallic wires 20-2 forming the first electrode pattern 21 and the second electrode pattern 22 and an aperture ratio per unit area of the first electrode pattern 21 and the second electrode pattern 22 is designed to be 1% or less, the visibility of the electrode pattern 20 may be more appropriate.

The insides of the first electrode patterns 21 or the second electrode patterns 22 may be further provided with dummy electrodes 21b which are insulated from the respective electrode patterns 20 and have the same pattern as any one of the electrode patterns 20. The dummy electrode 21b may more effectively resolve the visibility problem which may occur due to a morphological difference between the respective electrode patterns 20 which is caused by the relative density difference between the thin metallic wires 20-2 of the first electrode pattern 21 and the second electrode pattern 22.

The dummy electrode 21b may be formed in any one of the electrode patterns 20 having the relatively small density value. Additionally, the dummy electrode 21b may be formed in each of the electrode patterns 20 but is formed with the same pattern as the electrode pattern 20 to correct the difference in the patterns between the first electrode pattern 21 and the second electrode pattern 22, thereby reducing the visibility of the electrode pattern 20.

When the dummy electrode 21b is made of the same or similar conductive metal as or to the electrode pattern 20, the dummy electrodes 21b may be formed to be spaced apart to from the respective electrode patterns 20, thereby keeping the insulation between the dummy electrode 21b and the electrode pattern 20. The dummy electrode 21b may be made of an insulating material, thereby more effectively reducing the visibility of the electrode pattern 20. Further, when the dummy electrode 21b is made of the conductive material, the dummy electrode 21b may be partially connected to or disconnected from the electrode pattern 20, thereby controlling the mutual capacitance between the electrode patterns 20.

The dummy electrode 21b may be formed in only one or both of the first electrode pattern 21 and the second electrode pattern 22. In this case, even though the dummy electrode 21b is formed, the difference between the aperture ratios per unit area of the first electrode pattern 21 and the second electrode pattern 22 may be formed to be 1% or less. Alternatively, the dummy electrode 21b is formed to keep the aperture ratios per unit area of each of the first electrode pattern 21 and the second electrode pattern 22 the same, thereby reducing the visibility of the electrode pattern 20.

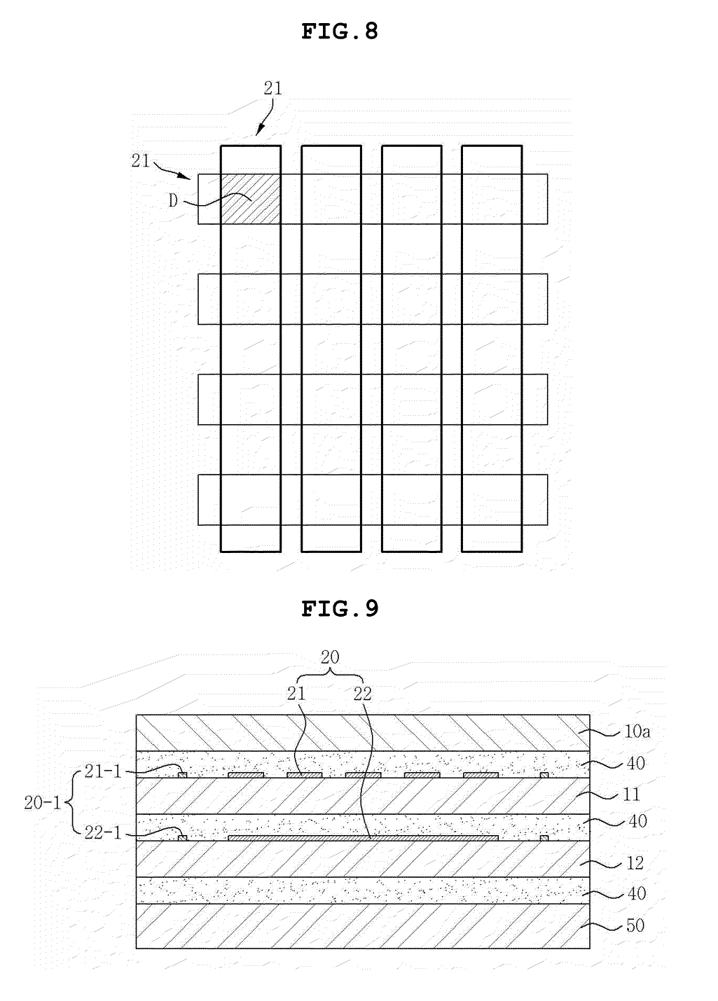

FIG. 8 is a plan view illustrating a region in which the first electrode pattern 21 and the second electrode pattern 22 according to the preferred embodiment of the present invention face each other.

As illustrated in FIG. 8, when the region in which the first electrode pattern 21 and the second electrode pattern 22 overlap each other on a plane is indicated by D, similar to the foregoing description, the first and second electrode patterns 21 and 22 may be formed so that the area value occupied by the thin metallic wire 20-2 in the corresponding region D in the first electrode pattern 21 and the area value occupied by the thin metallic wire 20-2 in the corresponding region D of the second electrode pattern 22 may be different from each other. That is, the first and second electrode patterns 21 and 22 may be formed so that the relative difference between the area values occupied by the thin metallic wires 20-2 on the areas corresponding in both of the electrode patterns 21 and 22, that is, the density values of the thin metallic wires 20-2 is formed. The action effect of the relative difference between the thin metallic wires 20-2 of the respective electrode patterns 21 and 22 is described above and therefore the detailed description thereof will be omitted.

The electrode pattern 20 and the dummy pattern 21b may be formed in the mesh pattern using copper (Cu), aluminum (Al), gold (Au), silver (Ag), titanium (Ti), palladium (Pd), chromium (Cr), nickel (Ni) or a combination thereof. The mesh pattern may be formed by continuously arranging at least one unit pattern 20a, in which the unit pattern 20a may be formed in a quadrangle, a triangle, a diamond, and other various shapes but the preferred embodiment of the present invention illustrates the form in which the mesh unit patterns having the diamond shape are continuously arranged. As described above, the dummy electrode 21b may be made of an insulating material without conductivity different from the electrode pattern 20.

The electrode pattern 20 may also be formed using metal silver formed by exposing/developing a silver salt emulsion layer, metal oxides such as indium thin oxide (ITO), etc., or a conductive polymer such as PEDOT/PSS, or the like, having excellent flexibility and a simple coating process, in addition to the foregoing metal. Even in this case, the visibility problem of the electrode pattern 20 which may occur due to the shape or material of the electrode pattern 20 may be effectively resolved.

As a method of forming the electrode pattern 20, a dry process, a wet process, or a direct patterning process may be used. For example, the dry process includes sputtering, evaporation, and the like, the wet process includes dip coating, spin coating, roll coating, spray coating, and the like, and the direct patterning process means screen printing, gravure printing, inkjet printing, and the like.

Further, a photosensitive material may be applied on the electrode pattern 20 on the substrate by using photolithography and light is irradiated thereto using a mask formed in a desired pattern. In this case, a developing process for forming a desired pattern by removing a photosensitive material portion to which light is irradiated with a developer or removing a portion to which light is not irradiated with a developer is conducted. Next, the photosensitive material is formed in a specific pattern, the remaining portion is removed to with an etchant using the photosensitive material as a resist, and then the photosensitive material is removed, such that the electrode pattern 20 having the desired pattern may be manufactured.

As illustrated in FIG. 1, the first electrode patterns 21 and the second electrode patterns 22 are each formed on both surfaces of the transparent substrate 10 and the display unit 50 may be bonded to a lower portion of the second electrode pattern 22 through an adhesive layer 40. A window substrate 10a as a protective substrate for protecting the touch sensor may be bonded to an outermost layer of the sensing electrode of the first electrode pattern 21, to which the touch of the user is input, by the adhesive layer 40. The window substrate 10a may be generally made of the same material as the material of the transparent substrate 10 or a material having rigidity. Further, the display unit 50 displaying an output image in response to the input of the touch sensor may be bonded to the lower portion of the driving electrode of the second electrode pattern 22. Here, when a direction in which the window substrate 10a is formed is considered as an upper portion based on the drawing illustrated in FIG. 1, the lower portion of the driving electrode means a lower end direction in an opposite direction to the direction.

Further, as illustrated in FIG. 9, a touch sensor according to another preferred embodiment of the present invention may be implemented by forming the first electrode pattern 21 on one surface of the first transparent substrate 11, forming the second electrode pattern 22 on a separate second transparent substrate 12, and bonding the transparent substrates 11 and 12 to each other.

Although not illustrated, the first electrode pattern 21 and the second electrode pattern 22 are stacked and bonded to each other by using an insulating resin therebetween, such that the touch sensor may be implemented using one transparent substrate 10. That is, the touch sensor may be implemented to be thinner by forming the first electrode pattern 21 on the transparent substrate 10, forming the insulating resin on the first electrode pattern 21, and forming the second electrode pattern 22 on the insulating resin. The touch sensor in to which the first electrode pattern 21 and the second electrode pattern 22 are disposed to be spaced from each other may be implemented by various methods and structures which are included in a scope which may be designed by those skilled in the art.

Others, the detailed description of the overlapping configuration of the first transparent substrate 11 and the second transparent substrate 12, the first electrode pattern 21 and the second electrode pattern 22, and the dummy electrode 21b, and the like overlaps the contents of the touch sensor according to the preferred embodiment of the present invention, and therefore the description thereof will be omitted herein.

According to the preferred embodiments of the present invention, the width of the first electrode pattern 21 serving as the sensing electrode may be more increased to reduce the short wire badness of the mesh pattern which may occur during the process forming the first electrode pattern 21, thereby securing the operation reliability of the touch sensor.

Further, it is possible to more reliably keep the control of the mutual capacitance while implementing the reduction in the visibility with the same width direction length by putting the density difference of the thin metallic line forming the first electrode pattern and the second electrode pattern.

In addition, it is possible to more effectively control the capacitance in the electrode pattern by forming the cutting parts inside the electrode pattern.

Further, it is possible to appropriately control the mutual capacitance between the driving electrode and the sensing electrode by forming the unit pattern of the mesh pattern of the sensing electrode having the pitch larger than that of the unit pattern of the mesh pattern of the driving electrode while forming the sensing electrode in the relatively wide width.

Further, it is possible to reduce the visibility of the electrode pattern 20 while increasing the touched area at the time of the user touch, by removing the inactive region insulated between the respective patterns in which the first electrode pattern 21 and the second electrode pattern 22 are formed.

Further, to reduce the visibility of the electrode pattern 20 due to the non-uniformity of the pattern which may occur by making the pitch of the first unit pattern 21a forming the first electrode pattern 21a larger than that of the second unit pattern 22a forming the second electrode pattern 22, the dummy electrode 21b may be formed inside the first unit pattern 21a and the first unit pattern 21a and the second unit pattern 22a in which the dummy electrodes 21b are formed are implemented to be same, thereby implement the uniform mesh pattern.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch sensor, comprising:
a transparent substrate;
first electrode patterns formed on one surface of the transparent substrate;
second electrode patterns formed to intersect with the first electrode patterns, the second electrode patterns spaced apart from the first electrode patterns; and
wiring parts formed on one or more ends of the first and second electrode patterns to electrically connect between the first electrode patterns and the second electrode patterns,
wherein the first and second electrode patterns comprise thin metallic wires conducting with the wiring parts,
wherein an area occupied by the thin metallic wires per unit area on the first electrode pattern is different from an area occupied by the thin metallic wires per unit area on the second electrode pattern.

2. The touch sensor as set forth in claim 1, wherein the first electrode pattern is a sensing electrode, and the second electrode pattern is a driving electrode.

3. The touch sensor as set forth in claim 1, wherein widths of the first electrode patterns and the second electrode patterns are formed to correspond to each other.

4. The touch sensor as set forth in claim 1, wherein the second electrode patterns are formed on another surface of the transparent substrate.

5. The touch sensor as set forth in claim 1, further comprising another transparent substrate, wherein the second electrode patterns are formed on the another transparent substrate to be spaced apart from the first electrode patterns in a direction facing each other.

6. The touch sensor as set forth in claim 1, further comprising:
an insulating resin formed on the transparent substrate and between the first electrode patterns and the second electrode patterns on one surface thereof.

7. The touch sensor as set forth in claim 1, wherein the area occupied by the thin metallic wires on the first electrode pattern and the area occupied by the thin metallic wires on the second electrode pattern are different from each other within an area corresponding to a region in a stacked direction of the first electrode pattern and the second electrode pattern.

8. The touch sensor as set forth in claim 1, wherein the area occupied by the thin metallic wires per unit area on the first electrode pattern is formed to be smaller than the area occupied by the thin metallic wires per unit area on the second electrode pattern.

9. The touch sensor as set forth in claim 1, wherein the area occupied per unit area of the thin metallic wires is determined by any one of a line width, a pitch, and a pattern of the thin metallic wires or a combination thereof.

10. The touch sensor as set forth in claim 1, further comprising:
a dummy electrode formed inside the first electrode patterns and formed to be insulated from the first electrode patterns.

11. The touch sensor as set forth in claim 10, wherein the dummy electrode is formed inside the first electrode patterns so that a difference between an aperture ratio per unit area of the first electrode pattern and an aperture ratio per unit area of the second electrode pattern is 1% or less.

12. The touch sensor as set forth in claim 10, wherein the dummy electrode formed inside the first electrode patterns is formed with a pattern corresponding to the second electrode patterns.

13. The touch sensor as set forth in claim 1, further comprising:
one or more first unit patterns formed inside the first electrode patterns; and
one or more second unit patterns formed inside the second electrode patterns.

14. The touch sensor as set forth in claim 13, wherein the number of the first unit patterns formed per unit length in one direction in which the first electrode patterns and the second electrode patterns correspond to each other is smaller than the number of the second unit patterns.

15. The touch sensor as set forth in claim 13, wherein the number of the second unit patterns formed per unit length in one direction in which the first electrode patterns and the second electrode patterns correspond to each other is formed to be an integer multiple of the number of the first unit patterns.

16. The touch sensor as set forth in claim 14, wherein the number of the first unit patterns formed per unit length in another direction intersecting with one direction in which the first electrode patterns and the second electrode patterns correspond to each other is smaller than the number of the second unit patterns.

17. The touch sensor as set forth in claim 16, wherein the number of the second unit patterns formed per unit length in the another direction intersecting with the one direction in which the first electrode patterns and the second electrode patterns correspond to each other is formed to be an integer multiple of the number of the first unit patterns.

18. The touch sensor as set forth in claim 13, wherein the thin metallic wires have a closed loop structure.

19. The touch sensor as set forth in claim 10, wherein:
the first electrode patterns comprise at least one first unit pattern having a closed loop structure formed inside the first electrode patterns, and
the dummy electrode is formed inside the closed loop.

20. The touch sensor as set forth in claim 1, further comprising:
at least one cutting part for controlling mutual capacitance formed inside the first electrode patterns.

21. The touch sensor as set forth in claim 2, further comprising:
a window substrate formed at an outermost of the sensing electrode to which a touch of a user is input; and
a display unit formed to be disposed at a lower portion of the driving electrode.

22. A touch sensor, comprising:
a transparent substrate;
first electrode patterns formed on one surface of the transparent substrate; and
second electrode patterns disposed to be spaced apart from the first electrode patterns,
wherein a mesh density of the first electrode patterns is different from a mesh density of the second electrode patterns.

23. The touch sensor of claim 22, further comprising one or more dummy electrodes arranged inside one of the first electrode patterns and the second electrode patterns which has a lower mesh density than the other, or inside both of the first and second electrode patterns.

24. The touch sensor of claim 23, wherein the dummy electrodes are formed to be insulated from the first and/or second electrode patterns.

25. The touch sensor of claim 22, further comprising a short wire part between the first electrode patterns and/or between the second electrode patterns.
